(19) United States
(12) Patent Application Publication
(10) Pub. No.: US 2014/0324582 A1
(43) Pub. Date: Oct. 30, 2014

(54) SOCIAL NETWORK ENHANCED CONTENT ITEMS RESPONSIVE TO SEARCH QUERIES

(71) Applicant: Google Inc., (US)

(72) Inventors: Dani SULEMAN, Fremont, CA (US); Chuan Jiang, Sunnyvale, CA (US); Shreyas Doshi, Mountain View, CA (US); Lakshmi Kumar Dabbiru, Sunnyvale, CA (US); Daniel Aaron Shaffer, Palo Alto, CA (US); Varouj Armen Chitilian, Hillsborough, CA (US); Emily Moxley, San Francisco, CA (US); Vinod Aanupam, Mountain View, CA (US); Hobart Runa Sze, Palo Alto, CA (US)

(73) Assignee: Google Inc., Mountain View, CA (US)

(21) Appl. No.: 13/874,432

(22) Filed: Apr. 30, 2013

(51) Int. Cl. G06Q 30/02

(52) U.S. Cl. CPC G06Q 30/0256
USPC 705/14.54

(57) ABSTRACT

Methods for identifying social network users to display with an advertisement in response to a search query are provided. In one aspect, a method includes receiving a search query from a user, the user having a user presence on a social network, and identifying at least one advertisement responsive to the search query, the at least one advertisement associated with an entity having a social presence on the social network. The method also includes identifying another user of the social network that has a mutual user connection with the user on the social network and has interacted with the social presence on the social network, and providing, for display and in response to the search query, the at least one advertisement responsive to the search query, an identification of the other user, and an indicator of the interaction of the other user. Systems and machine-readable media are also provided.

### BACKGROUND

1. Field

The present disclosure generally relates to the transmission of data over a network, and more particularly to the use of a computing device to provide data responsive to a request sent over a network.

2. Description of the Related Art

A user conducting a search on a network for content responsive to a search query commonly receives a listing of search results that has some level of responsiveness to the search query. The listing will commonly include one or several advertisements that are also responsive to the search query. The advertisements are commonly paid for by advertisers, who often configure the advertisements to be displayed in response to particular search queries. For example, a user conducts a World Wide Web search for “sports car.” The listing of search results provided in response to the search query includes a listing of sports car related web pages, but also includes advertisements by three sports car manufacturers that have paid to have advertisements shown in response to the search query “sports car.” Although the paid advertisements are responsive to the user's search query, the user may not be inclined to select any of the advertisements because the user does not feel any personal affinity to the content of the advertisements or the manufacturers themselves.

### SUMMARY

According to one embodiment of the present disclosure, a computer-implemented method for identifying social network users to display with an advertisement in response to a search query is provided. The method includes receiving a search query from a user, the user having a user presence on a social network, and identifying at least one advertisement responsive to the search query, the at least one advertisement associated with an entity having a social presence on the social network. The method also includes identifying another user of the social network that has a mutual user connection with the user on the social network and has interacted with the social presence on the social network, and providing, for display and in response to the search query, the at least one advertisement responsive to the search query, an identification of the other user, and an indicator of the interaction of the other user.

According to another embodiment of the present disclosure, a system for identifying social network users to display with an advertisement in response to a search query is provided. The system includes a memory that includes instructions, and one or more processors. The one or more processors are configured to execute the instructions to receive a search query from a user, the user having a user presence on a social network, and identify at least one advertisement responsive to the search query and at least one search result responsive to the search query, the at least one advertisement associated with an entity having a social presence on the social network. The one or more processors are also configured to execute the instructions to identify another user of the social network that has a mutual user connection with the user on the social network and has interacted with the social presence on the social network, and provide, for display and in response to the search query, the at least one advertisement responsive to the search query, the at least one search result responsive to the search query, an identification of the other user, and an indicator of the interaction of the other user.

According to a further embodiment of the present disclosure, a machine-readable storage medium that includes machine-readable instructions for causing a processor to execute a method for identifying social network users to display with an advertisement in response to a search query is provided. The method includes receiving a search query from a user, the user having a user presence on a social network, and identifying at least one advertisement includes an advertisement responsive to the search query and at least one search result responsive to the search query, the at least one advertisement associated with an entity having a social presence on the social network, the social presence includes a web page of the entity on the social network. The method also includes identifying another user of the social network that has a mutual user connection with the user on the social network has interacted with the social presence on the social network, and providing, for display and in response to the search query, the at least one advertisement responsive to the search query, the at least one search result responsive to the search query, an identification of the other user, and an indicator of the interaction of the other user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for identifying social network users to display with a content item in response to a search query.

FIG. 2 is a block diagram illustrating an example client and servers from the architecture of FIG. 1 according to certain aspects of the disclosure.

FIG. 3 illustrates an example process for identifying social network users to display with a content item in response to a search query using an example client, search server, content server, and social server of FIG. 2.

FIG. 4 is an example illustration associated with the example process of FIG. 3.

FIG. 5 is a block diagram illustrating an example computer system with which the clients and servers of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system automatically identifies a user's social network connections (e.g., friends) and connections of the user's social network connections, and displays an identification of the connections of the connections in an advertisement or other content item responsive to the user's search query. The user is thus provided with a level of personal affinity to the advertisement. The identified connections can, for example, have expressed some level of interaction (e.g., endorsement, review, subscription, etc.) with an entity, such as an advertiser, responsible for the content item provided for display in response to the user's search query. The entity may initially associate the entity's social presence (e.g., the entity's home page on the social network) with the content item in order to facilitate identification of the social network connections. The identification of social network connections in a content item adds significant value for both the entity and the user. For example, a user David conducts a World Wide Web search for “sports cars.” The listing of search results includes a search advertisement by sports car manufacturer ACME with a personal annotation “Joe, John and Ryan follow ACME” as an additional piece of content attached to the search advertisement for ACME. David is connected to Joe, John, and Ryan indirectly on a social network through a mutual friend Tom, and Joe, John, and Ryan follow the advertiser on social network. Therefore, David knows his friend Tom's friends Joe, John, and Ryan follow ACME and therefore David will likely be more inclined to select the advertisement from ACME over a competing advertisement.

Although many examples provided herein describe a user's information (e.g., user interactions with entities, social network connections) being stored in memory, each user must grant explicit permission for such user information to be stored. The explicit permission may be granted using privacy controls integrated into the disclosed system. If requested user information includes demographic information, then the demographic information is aggregated on a group basis and not by individual user. Each user is provided notice that such user information will be stored with such explicit consent, and each user may at any time end having the user information stored, and may delete the stored user information. The stored user information may be encrypted to protect user security.

The user can at any time delete the user information from memory and/or opt out of having the user information stored in memory. Additionally, the user can, at any time, adjust appropriate privacy settings to selectively limit the types of user information stored in memory, or select the memory in which the user information is stored (e.g., locally on the user's device as opposed to remotely a server). In many examples, the user information does not include and/or share the specific identification of the user (e.g., the user's name) unless otherwise specifically provided or directed by the user.

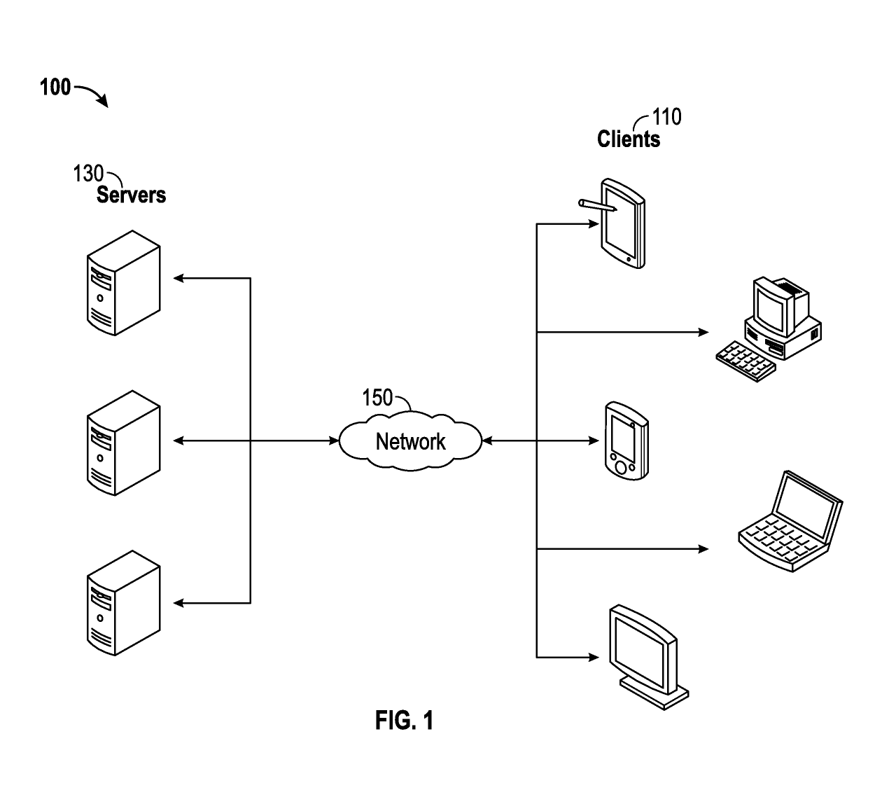

FIG. 1 illustrates an example architecture 100 for identifying social network users to display with a content item in response to a search query. The architecture 100 includes servers 130 and clients 110 connected over a network 150.

Each of the clients 110 is configured to run (e.g., from memory using a processor) a client application for receiving a search query and providing content items and search results responsive to the search query. In certain aspects, the client application is optimized for display on the respective client 110. The clients 110 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities for running the client application.

The client application sends the search query over a network 150 to one of the many servers 130, such as a search server that hosts a search server application. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like. For purposes of load balancing, multiple servers 130 can host the search server application, either completely (e.g., data replication) or in part. The search server application receives the search query and identifies at least content item (e.g., advertisement) responsive to the search query, and identifies another user that is both associated with the user on the social network and has interacted with the entity responsible for the content item. The servers 130 can be any device having an appropriate processor, memory, and communications capability for hosting a search server application, content items, and social data.

The content item can be identified, for example, by the search server application referencing content items on the same server 130 or another server 130 (e.g., over the network 150), such as a content server. For purposes of load balancing, multiple servers 130 can host the content items, either completely (e.g., data replication) or in part. Similarly, the other user, who can be a connection of a connection of the user (e.g., having at least one degree of separation from the user), can be identified, for example, by the search server application referencing social data on the same server 130 or another server 130 (e.g., over the network 150), such as a social server. For purposes of load balancing, multiple servers 130 can host the social data, either completely (e.g., data replication) or in part.

Once the content item and the other user are identified, the search server application provides the content item and the identification of the other user to the client application on the client 110 for display in response to the search query and search results responsive to the search query. The content item, which may be displayed with the search results, includes an identification of the other user and the other user's interaction with the entity responsible for the content item (e.g., the advertiser). As such, the user who submitted the search query will have a greater affinity to, and is more likely to interact with, the content item because the user is made aware of the other user's interaction.

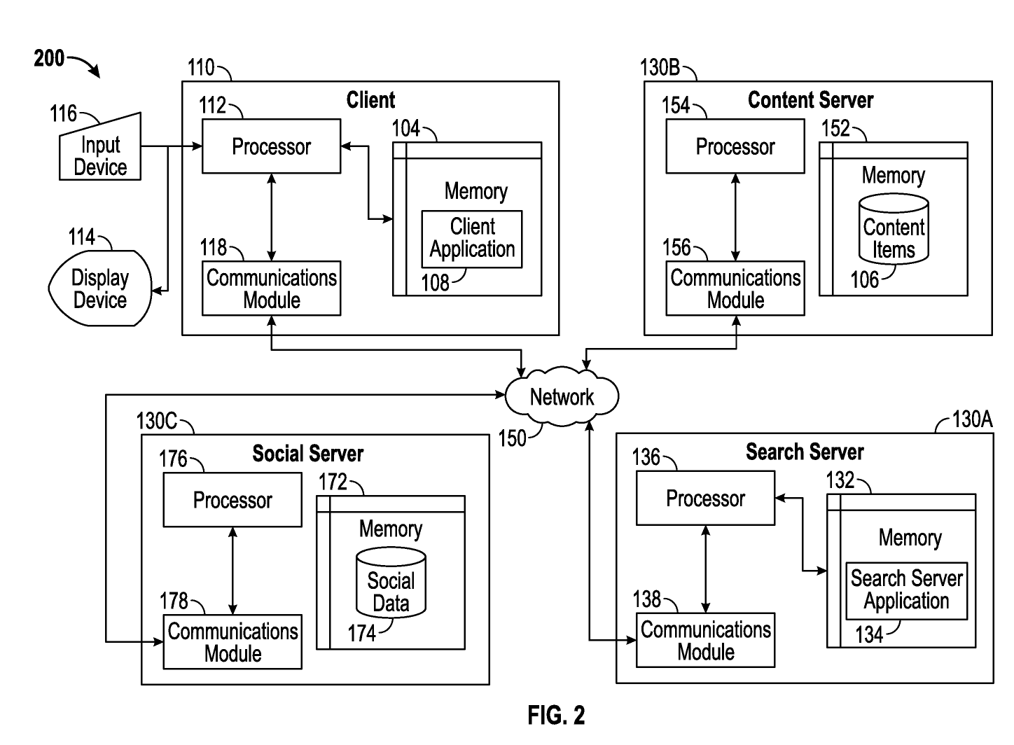

FIG. 2 is a block diagram 200 illustrating an example client 110, search server 130A, content server 130B, and social server 130C in the architecture 100 of FIG. 1 according to certain aspects of the disclosure. The client 110, search server 130A, content server 130B, and social server 130C are connected over the network 150 via respective communications modules 118, 138, 156, and 178. The communications modules 118, 138, 156, and 178 are configured to interface with the network 150 to send and receive information, such as data, requests, responses, and commands to other devices on the network. The communications modules 118, 138, 156, and 178 can be, for example, modems or Ethernet cards.

The search server 130A includes a processor 136, a communications module 138, and a memory 132 that includes a search server application 134. The processor 136 of the search server 130A is configured to execute instructions, such as instructions physically coded into the processor 136, instructions received from software in memory 132, or a combination of both. For example, the processor 136 of the search server 130A executes instructions from the search server application 134 to receive a search query from a user (e.g., provided to the client 110 using an input device 116 of the client 110) having a user presence on a social network. The search query is provided to the search server 130A from the client 110. The social network can be hosted at least in part by the social server 130C, which stores social data 174 for the social network in memory 172.

The processor 136 of the search server 130A is configured identify at least one content item responsive to the search query. For example, the processor 136 of the search server 130A sends a request over the network 150 to the processor 154 of the content server 130B requesting an identification of a content item responsive to the search query. The processor 154 of the content server 130B identifies a content item from a plurality of content items 106 in memory 152 and sends data regarding the identified content item back to the search server 130A over the network 150 in response to the request. The content item may be associated with a social presence on the social network.

The content item can be, for example, an advertisement, a notification, a video, an image, text, or other content representative of an entity having a social presence of the entity on social network. For instance, the content item can be an advertisement for a detergent made by a detergent company having a landing or other web page stored as part of the social data 174 in the memory 172 of the social server 130C hosting the social network. As discussed herein, a landing page is a single web page that appears in response to clicking on a search engine optimized search result or an online advertisement. The landing page will usually display directed sales copy that is a logical extension of the advertisement, search result or link.

The entity may explicitly link or otherwise associate the social presence of the entity on the social network as stored in the social data 174 with relevant content items 106 of the entity stored on the content server 130B. For example, a representative of the entity can use an interface, such as a web application, to either the content items 106 on the content server 130B or the social data 174 on the social server 130C to explicitly identify and link a social media presence of the entity in the social data 174 with content items 106 provided by the entity among the content items 106 on the content server 130B. The social presence of the entity on the social network can also be automatically linked, for example, by the search server 130A with relevant content items 106 of the entity stored on the content server 130B.

The processor 136 of the search server 130A is also configured to identify another user of the social network that is both associated with the user and the social presence of an entity on the social network. For example, the processor 136 of the search server 130A can send a request over the network 150 to the processor 176 of the social server 130 to identify another user of the social network that is both associated, through a mutual connection, with the user and associated with the social presence of the entity on the social network. The other user can be identified (e.g., by the processor 176 of the social server 130C) as having a mutual connection with the user on the social network (e.g., a friend of a friend). The other user can be identified as being associated with the social presence (e.g., of the entity associated with the content item) by identifying at least one interaction between the other user and the social presence of the entity on the network. For example, the other user may have endorsed (e.g., +1, like, thumbs up, or other indication of endorsement), reviewed, checked in at, mentioned, or subscribed to the social presence of the entity (e.g., web page of the entity) on the social network. The interactions may be weighted, such as where an endorsement of a social presence of the entity has a higher weight than a subscription to the social presence of the entity. The weight of the interactions may be used in determining which user(s) to identify with the content item in response to the search query.

One or many other such users that have a mutual connection with the user can be identified. In certain aspects where multiple other such users having a mutual connection with the user are identified, an affinity or “friend-suggestion” algorithm as disclosed by U.S. patent application Ser. No. 12/762,081, entitled “Generating Contact Suggestions,” filed on Apr. 16, 2010, and incorporated by reference herein, may be used to select which of the other users to identify with the content item based on those selected users' degree of affinity to the user providing the search query. For instance, reference may be made to an implicit social graph of the social network, which is defined by interactions between users and their contacts and groups on the social network. The implicit social graph can be a weighted graph where edge weights are determined by the frequency, recency, and direction of interactions between users and their contacts and groups. The friend-suggestion algorithm provides more accurate contact suggestions by taking into account group interactions and peer-to-peer interactions. The implicit social graph may be used to identify clusters of contacts that form groups that are meaningful and useful to each user, without considering the content of interactions. Other users having mutual connections with a user (e.g., friends of friends) are considered when computing edge weights for the graph, and when computing contact clusters. The friend-suggestion algorithm provides, given a user's social network with weighted edges from the implicit social graph and an initial seed of a few contacts, a scoring of other users having a mutual connection with the user. A subset of the identified other users can be selected, for example, if they exceed a certain threshold affinity score.

The processor 136 of the search server 130A is further configured to provide, for display and in response to the search query, a content item responsive to the search query and an identification of the other user(s). For example, the processor 136 of the search server 130A can provide a copy of the content item and the identification of the other user over the network 150 to the processor 112 of the client 110 for display by the client application 108 on the display device 114 of the client 110. In certain aspects where the content item and the identification of the other user are provided by the processor 136 of the search server 130A along with at least one search result responsive to the search query, then, for example, the client application 108 may display the content item and the identification of the other user(s) with the search result for display in the client application 108 in response to the search query. For instance, the client application 108 can display a search results page provided by the search server application 134 in response to the search query by the user, and the search results page can include a content item, such as an advertisement, that is both relevant to the search query and that identifies another user having a mutual connection with the user and how that other user has interacted with the entity associated with the content item.

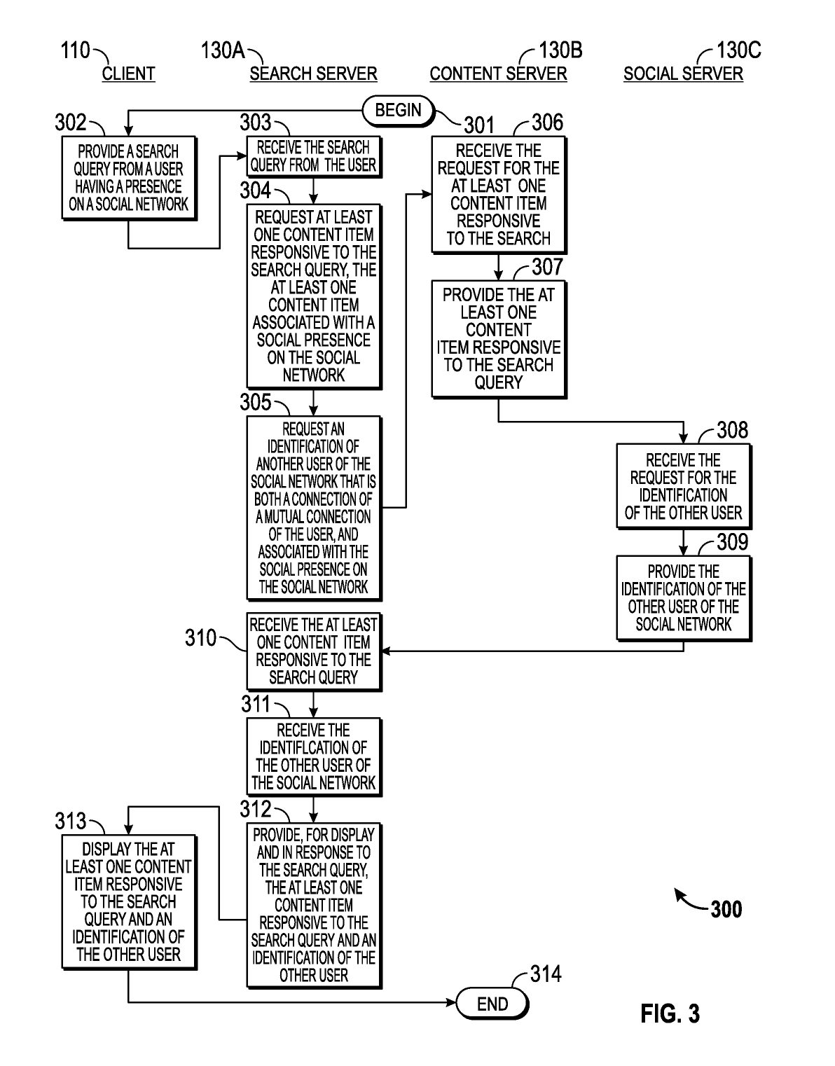

FIG. 3 illustrates an example process 300 for identifying social network users to display with a content item in response to a search query using the example client 110, search server 130A, content server 130B, and social server 130C of FIG. 2. While FIG. 3 is described with reference to FIG. 2, it should be noted that the process steps of FIG. 3 may be performed by other systems.

The process 300 begins by proceeding from beginning step 301 when the client application 108 is loaded on the client 110 and a search query is received in the client application 108 (e.g., using input device 116) from a user having a presence on a social network, to step 302 when the search query is provided to the search server 130A. Next, in step 303, the search server 130A receives the search query from the user and in step 304 requests, from the content server 130B, at least one content item that is both responsive to the search query and associated with a social presence of an entity on the social network. In step 305, the search server 130A requests, from the social server 130C, an identification of another user of the social network that both has a mutual connection (e.g., a mutual friend) with the user (i.e., that provided the search query in step 301) and is associated with the social presence of the entity (i.e., of step 304) on the social network.

In step 306, the content server 130B receives the request for the content item that is responsive to the search query, and in step 307 provides the content item to the search server 130A. In step 308, the social server 130C receives the request for the identification of the other user of the social network that has a mutual user connection with the user and is associated with the social presence of the entity on the social network, and in step 309 provides the identification of the other user to the search server 130A.

In step 310, the search server 130A receives the content item provided by the content server 130B in step 307, and in step 311 the search server 130A receives the identification of the other user provided by the social server 130C in step 309. In step 312, the search server 130A provides, for display and in response to the search query (e.g., provided by the client 110 in step 302), the content item and the identification of the other user to the client 110.

In step 313, the client displays the content item responsive to the search query and the identification of the other user (i.e., that is both associated, on the social network, with the user through a mutual connection and is associated with the social presence of the entity, the social presence being associated with the content item). The process 300 ends in step 314.

FIG. 3 set forth an example process 300 for identifying social network users to display with a content item in response to a search query using the example client, search server, content server, and social server of FIG. 2. An example will now be described using the example process 300 of FIG. 3 and a search query for “termite control” submitted to a client application 108 that is a web browser.

The process 300 begins by proceeding from beginning step 301 when the web browser 108 is loaded on the client 110 and a search query for “termite control” is received in the web browser 108 from a user having a presence on a social network, to step 302 when the “termite control” search query is provided by the web browser 108 to the search server 130A. Next, in step 303, the search server 130A receives the “termite control” search query from the user and in step 304 requests, from the content server 130B, an advertisement that is both responsive to the “termite control” search query and associated (e.g., linked) with a landing page of a company on the social network. In step 305, the search server 130A requests, from the social server 130C, an identification of another user of the social network that is both (1) connected to a connection of the user (e.g., having at least one degree of separation from the user), and (2) has interacted with the landing page of the company on the social network.

In step 306, the content server 130B receives the request for the content item that is responsive to the search query, and in step 307 provides the content item to the search server 130A. In step 308, the social server 130C receives the request for the identification of the other user of the social network that is both associated with the user through a mutual connection and is associated with the social presence of the entity on the social network, identifies that a friend Jon A of the user's friend Tom B has endorsed the company, and in step 309 provides the identification of Jon A and Tom B to the search server 130A.

In step 310, the search server 130A receives a copy of the advertisement provided by the content server 130B in step 307, and in step 311 the search server 130A receives the identification of Jon A and Tom B, and Jon's endorsement of the company as provided by the social server 130C in step 309. In step 312, the search server 130A provides, in response to the “termite control” search query provided by the client 110 in step 302, a web page comprising code to display a listing of search results responsive to the “termite control” search query, the advertisement provided by the content server 130B, and the identification of Jon A, Tom B, and Jon's endorsement provided by the social server 130C.

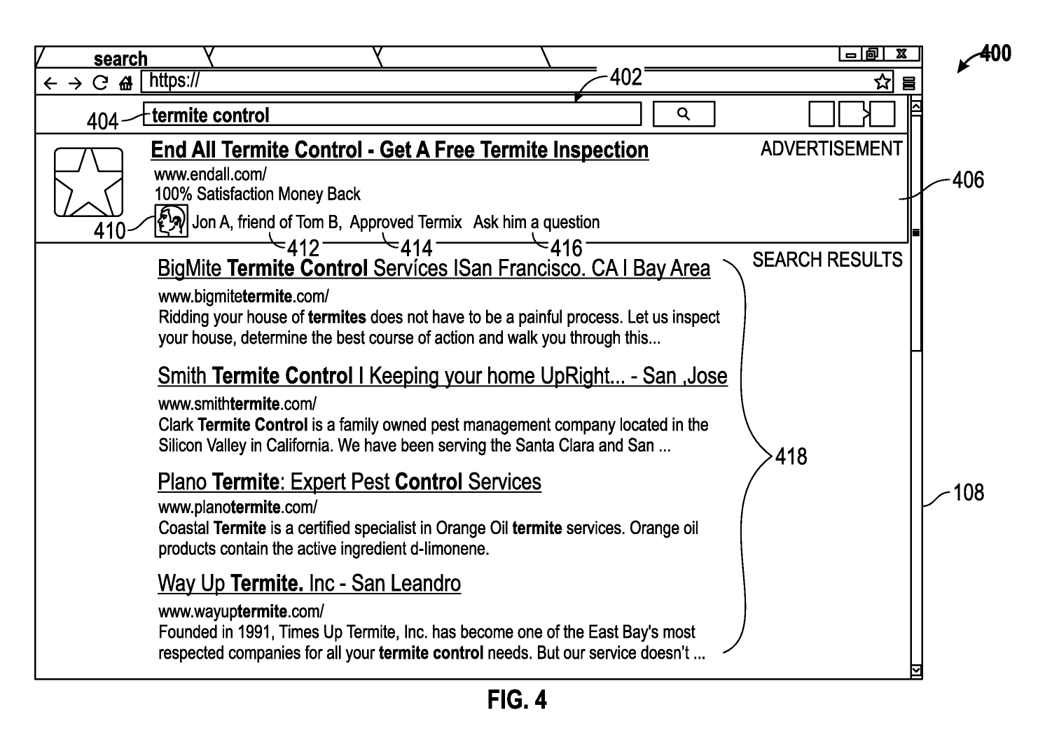

In step 313, the web browser 108 displays the web page as provided in the example illustration 400 of FIG. 4. The web page is displayed by the display device 114 of the client 110 in the web browser 108. The web page includes a search query input field 402, the user provided search query for “termite control” 505, the listing of search results 418, and an advertisement 406. The advertisement 406 is for a termite control company as indicated by the linked title 408 of the advertisement 406, and further identifies that Jon A is a friend of the user's friend Tom B 512, and that Jon A has approved 515 the termite control company. The advertisement 406 further includes an interface 416 for the user to ask Jon A a question about Jon A's interaction with the termite control company. The advertisement 406 yet further includes an image 410 of Jon A. The process 300 ends in step 314.

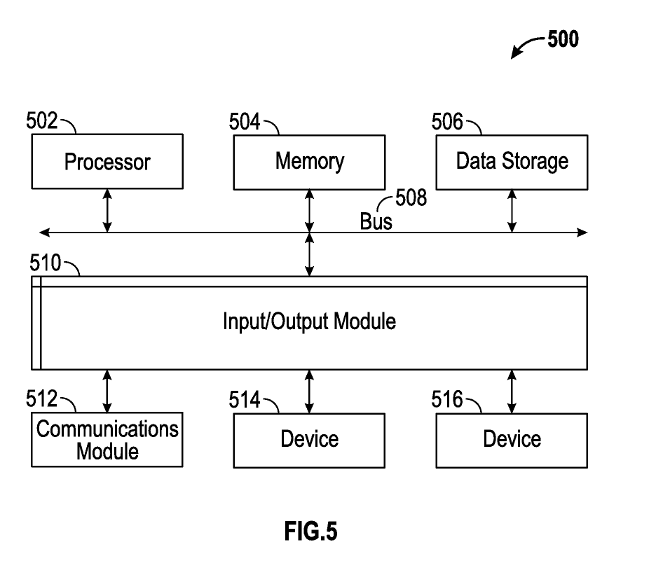

FIG. 5 is a block diagram illustrating an example computer system 500 with which the client 110, search server 130A, content server 130B, and social server 130C of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110, search server 130A, content server 130B, and social server 130C) includes a bus 508 or other communication mechanism for communicating information, and a processor 502 (e.g., processor 112, 136, 154, and 176) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 104, 134, 152, and 172), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., communications module 118, 138, 156, and 178) include networking interface cards, such as Ethernet cards and modems. In certain aspects, the input/output module 510 is configured to connect to a plurality of devices, such as an input device 514 (e.g., input device 116) and/or an output device 516 (e.g., output device 114). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110, search server 130A, content server 130B, and social server 130C can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A computer-implemented method for identifying social network users to display with an advertisement in response to a search query, the method comprising:
receiving a search query from a user, the user having a user presence on a social network;
identifying at least one advertisement responsive to the search query, the at least one advertisement associated with an entity having a social presence on the social network;
identifying another user of the social network that has a mutual user connection with the user on the social network and has interacted with the social presence on the social network; and
providing, for display and in response to the search query, the at least one advertisement responsive to the search query, an identification of the other user, and an indicator of the interaction of the other user.

2. The method of claim 1,
wherein a plurality of other users are identified that are both a connection of a mutual connection of the user on the social network and associated with the social presence on the social network and provided for display,
wherein the identification of the plurality of other users is provided for display in response to the search query with the at least one advertisement responsive to the search query, and
wherein the plurality of other users is selected, based on an affinity algorithm, from a larger group of users that are both a connection of a mutual connection of the user on the social network and associated with the social presence on the social network.

3. The method of claim 1, the method further comprising:
identifying at least one search result responsive to the search query; and
providing the at least one search result for display in response to the search query.

4. The method of claim 3, wherein the advertisement is provided for display with the at least one search result.

5. The method of claim Error! Reference source not found., wherein the social presence comprises a web page of the entity on the social network.

6. The method of claim 1, wherein the social presence on the network is configured to be associated with the advertisement.

7. The method of claim 1, wherein the interaction comprises an endorsement of the entity by the other user.

8. The method of claim 1, wherein the interaction comprises a review of the entity by the other user.

9. The method of claim 1, wherein the interaction comprises a check-in with the entity by the other user.

10. The method of claim 1, wherein the interaction comprises a mention of the entity by the other user.

11. The method of claim 1, wherein the interaction comprises a subscription to the entity by the other user.

12. A system for identifying social network users to display with an advertisement in response to a search query, the system comprising:
a memory comprising instructions; and
one or more processors configured to execute the instructions to:
receive a search query from a user, the user having a user presence on a social network;
identify at least one advertisement responsive to the search query and at least one search result responsive to the search query, the at least one advertisement associated with an entity having a social presence on the social network;
identify another user of the social network that has a mutual user connection with the user on the social network and has interacted with the social presence on the social network; and
provide, for display and in response to the search query, the at least one advertisement responsive to the search query, the at least one search result responsive to the search query, an identification of the other user, and an indicator of the interaction of the other user.

13. The system of claim 12,
wherein a plurality of other users are identified that are both a connection of a mutual connection of the user on the social network and associated with the social presence on the social network and provided for display,
wherein the identification of the plurality of other users is provided for display in response to the search query with the at least one advertisement responsive to the search query, and
wherein the plurality of other users is selected, based on an affinity algorithm, from a larger group of users that are both a connection of a mutual connection of the user on the social network and associated with the social presence on the social network.

14. The system of claim 12, wherein the advertisement is provided for display with the at least one search result.

15. The system of claim 12, wherein the social presence comprises a web page of the entity on the social network.

16. The system of claim 12, wherein the social presence on the network is configured to be associated with the advertisement.

17. The system of claim 12, wherein the interaction comprises at least one of an endorsement, review, check-in, mention, or subscription.

18. The system of claim 12, wherein the interaction comprises an endorsement of the entity by the other user.

19. The system of claim 12, wherein the interaction comprises a review of the entity by the other user.

20. The system of claim 12, wherein the interaction comprises a check-in of the entity by the other user.

21. The system of claim 12, wherein the interaction comprises a mention of the entity by the other user.

22. The system of claim 12, wherein the interaction comprises a subscription to the entity by the other user.

23. A machine-readable storage medium comprising machine-readable instructions for causing a processor to execute a method for identifying social network users to display with an advertisement in response to a search query, the method comprising:
receiving a search query from a user, the user having a user presence on a social network;
identifying at least one advertisement comprising an advertisement responsive to the search query and at least one search result responsive to the search query, the at least one advertisement associated with an entity having a social presence on the social network, the social presence comprising a web page of the entity on the social network;
identifying another user of the social network that has a mutual user connection with the user on the social network and has interacted with the social presence on the social network; and
providing, for display and in response to the search query, the at least one advertisement responsive to the search query, the at least one search result responsive to the search query, an identification of the other user, and an indicator of the interaction of the other user.
